(19) United States
(12) Patent Application Publication
(10) Pub. No.: US 2022/0145111 A1
(43) Pub. Date: May 12, 2022

(54) INKJET OVERCOAT COMPOSITION

(71) Applicant: Hewlett-Packard Development Company, L.P., Spring, TX (US)

(72) Inventors: Raymond Adamic, Corvallis, OR (US); Kellie S. Dalby, Corvallis, OR (US)

(21) Appl. No.: 17/436,912

(22) PCT Filed: Dec. 2, 2019
(86) PCT No.: PCT/US2019/063967

§ 371 Date: Sep. 7, 2021

(51) Int. Cl. C09D 11/40; C09D 11/322; C09D 11/033; C09D 11/037; C09D 11/107

(52) U.S. Cl. CPC C09D 11/40; C09D 11/322; B82Y 30/00; C09D 11/037; C09D 11/107; C09D 11/033

(57) ABSTRACT

An inkjet overcoat composition includes an aqueous vehicle. The inkjet overcoat composition also includes modified silica nanoparticles dispersed in the aqueous vehicle and a sugar alcohol dissolved or dispersed in the aqueous vehicle. Each modified silica nanoparticle includes a silica core and a hydrotropic silane coupling agent attached to the silica core.

### BACKGROUND

In addition to home and office usage, inkjet technology has expanded to high-speed, commercial and industrial printing. Inkjet printing is a non-impact printing method that utilizes electronic signals to control and direct droplets or a stream of ink to be deposited onto media. Methods used in current inkjet technology make use of thermal ejection, piezoelectric pressure or oscillation onto the surface of the media to force the ink drops through small nozzles. Inkjet technology has grown to be a popular method for recording images on various media surfaces (e.g. paper), for numerous reasons; including low printer noise, capability of high-speed recording and multi-color recording.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram of an example of a printing method;

FIGS. 2A through 2D are black and white reproductions of originally colored photographs of three example prints including green ink and an example of the overcoat composition disclosed herein and one comparative example print including green ink and a comparative overcoat composition;

FIGS. 3A and 3B are black and white reproductions of originally colored photographs of an example print including blue ink and an example of the overcoat composition disclosed herein and one comparative example print including blue ink and a comparative overcoat composition;

FIGS. 4A through 4F are black and white reproductions of originally colored photomicrographs of an example print including blue ink and an example of the overcoat composition disclosed herein and a comparative example print including blue ink and no overcoat composition;

FIGS. 5A through 5D are black and white reproductions of originally colored example prints and comparative prints after a decap test; and

FIGS. 6A and 6B are black and white reproductions of originally colored photographs of an example print and a comparative print after a capped recovery test.

### DETAILED DESCRIPTION

Inks used in thermal inkjet printing are often composed of water-soluble or water-miscible organic solvents (humectants, etc.), surfactants, and colorants, typically in a predominantly aqueous vehicle. When a recording is made on plain paper, the deposited colorants retain some mobility, which can manifest in poor bleed, edge acuity, feathering, and inferior optical density/chroma (due to penetration in the paper). These features adversely impact text and image quality.

In some attempts to reduce the occurrence of these features, coated papers or coating the paper immediately before printing with the inkjet ink have been utilized with inkjet systems. These coatings contain various components, such as fixers that react with inkjet ink component(s) to reduce colorant mobility and improve colorant hold-out (i.e., colorants tend to remain on the surface of the media). When colorant hold-out is improved, more colorant is present at the surface of the medium. While this may improve the optical density and/or chroma of the prints, this can also lead to less durable prints. In other words, these prints may be more susceptible to smearing, smudging, and/or scratching. Some attempts to improve print durability have included adding a polymeric binder and/or metal oxide particles to the inks. However, the addition of polymeric binder and/or metal oxide particles, e.g., in amounts higher than about 2 wt %, can introduce print reliability issues, in part because the ink viscosity increases and thermal inkjet printheads can clog more readily.

An inkjet overcoat composition is disclosed herein that improves the durability of prints on coated papers without compromising the jetting reliability of the inkjet system. The inkjet overcoat composition includes modified silica nanoparticles, each of which includes a silica core and a hydrotropic silane coupling agent attached to the silica core.

The hydrotropic silane coupling agent is specifically selected to increase the charge on the surface of the silica core. The increased charge improves the dispersability and stability of the modified silica nanoparticles in the inkjet overcoat composition. As such, higher amounts of the modified silica nanoparticles may be included, without deleteriously affecting the print reliability and decap performance.

The term “print reliability,” as used herein, generally refers to the ability of a print cartridge or pen to recover and successfully print after being stored capped for some extended period of time. During capped storage, the solids in an inkjet composition may settle out of the dispersed state and plug the nozzle(s) of the print cartridge or pen. If nozzles are completely plugged, the print cartridge or pen may be rendered useless.

The term “decap performance,” as referred to herein, means the ability of an inkjet composition to readily eject from the print cartridge or pen after being uncapped and unused. The decap performance may be measured as the amount of time that a print cartridge or pen may be left uncapped before the nozzles no longer fire properly, potentially because of clogging, plugging, or retraction of the solids from the drop forming region of the nozzle/firing chamber. As such, the decap performance can be measured in terms of time (i.e., decap time), which generally ranges from about 1 second up to about 5 minutes. Longer times may be referred to as “uncapped time” and may require several spits to restore the health of the printhead (e.g., to achieve acceptable quality drops). In these instances, the printhead may also be capped in order to achieve recovery, and the time to recovery may be referred to as “capped recovery.”

The modified silica nanoparticles may also contribute to improved durability of a print formed on coated papers, such as glossy, satin, and offset media. The print durability may be improved, in part, because of the small size of the modified silica nanoparticles. In the examples disclosed herein, the modified silica nanoparticles have a particle size ranging from about 5 nm to about 100 nm. In other examples, the modified silica nanoparticles have a particle size ranging from about 20 nm to about 50 nm, or from about 20 nm to about 30 nm, or from about 5 nm to about 50 nm, or from about 25 nm to about 75 nm. The term “particle size”, as used herein, refers to the diameter of a spherical particle, or the average diameter of a non-spherical particle (i.e., the average of multiple diameters across the particle), or the volume-weighted mean diameter of a particle distribution.

The small, charged modified silica nanoparticles also have a higher surface area compared to the larger colloidal particles, such as pigment particle. On any media type, the combination of the high number of the small nanoparticles with the high surface area may increase the binding interaction of the modified silica nanoparticles with larger components (e.g., binder particles, colorant particles, etc.) present in the ink when the ink is dried (e.g., when water and other co-solvent(s) are removed through absorption and evaporation). Improved binding interaction locks the colorant particles in place on the medium surface, thus improving print quality. Improved binding interaction may also create a stronger film at the medium surface, thus improving durability, especially in terms of scratch resistance.

Throughout this disclosure, a weight percentage that is referred to as “wt % active” refers to the loading of an active component of a dispersion or other formulation that is present in the inkjet overcoat or the inkjet ink. For example, a pigment may be present in a water-based formulation (e.g., a stock solution or dispersion) before being incorporated into the inkjet ink. In this example, the wt % actives of the pigment accounts for the loading (as a weight percent) of the pigment that is present in the inkjet ink, and does not account for the weight of the other components (e.g., water, etc.) that are present in the formulation with the white pigment. The term “wt %,” without the term actives, refers to either i) the loading (in the inkjet ink or the pre-treatment composition) of a 100% active component that does not include other non-active components therein, or the loading (in the inkjet ink or the overcoat composition) of a material or component that is used “as is” and thus the wt % accounts for both active and non-active components.

Modified Silica Nanoparticles

As mentioned, examples of the inkjet overcoat composition include modified silica nanoparticles.

The modified silica nanoparticles include a silica core. As such, the center of each modified nanoparticle includes silica. Silica molecules include a silicon atom chemically bonded to two oxygen atoms, and is also known as silicon dioxide, or SiO₂.

Suitable silicas that may be used for the core of the modified silica nanoparticles include anisotropic silica (e.g., elongated, covalently attached silica particles, such as PSM, which is commercially available from Nissan Chemical) or spherical silica dispersions (such as SNOWTEX® 30LH from Nissan Chemical). Other suitable commercially available silicas are sold under the tradename ORGANOSILICASOL™, which are organic solvent dispersed silica sols. In an example, the silica is anisotropic silica, spherical silica or a combination of anisotropic silica and spherical silica. Anisotropic silica dispersions have a higher aspect ratio compared to spherical silica.

The silica core may be a nanoparticle. The silica core nanoparticles have a particle size ranging from about 5 nm to about 50 nm. In another example, the silica core nanoparticles have a particle size ranging from about 10 nm to about 30 nm.

As mentioned, the silica cores are modified with a silane coupling agent (SCA). Silane coupling agents are compounds whose molecules contain functional groups that bond with both organic and inorganic materials, and thus have an organic substitution that alters the physical interactions of treated substrates. In the examples disclosed herein, hydrotropic silane coupling agents that increase the charge of the silica core have been found to enhance the overcoat performance.

The hydrotropic silane coupling agent may include at least one hydrotropic moiety (which had a hydrophilic and a hydrophobic part), or it may include both a hydrophobic moiety (e.g., a hydrophobic organofunctional group) and a hydrophilic moiety (e.g., an alkoxy or a halogen). The hydrotropic silane coupling agent structure can generally be represented as SiR¹R²R³R⁴. In some examples, at least one of the R groups is a hydrotrope and at least one of the R groups is a hydrolyzable moiety (e.g., e.g., an alkoxy, a halogen, dimethylamine or another amine, oxime). In other examples, at least one of the R groups is the hydrophobic moiety and at least one other of the R groups is a hydrophilic moiety. In any of the examples, any remaining R group is another functional group, such as H, a hydroxyl (—OH), an alkyl group (e.g., a C₁ to C₆ alkyl), etc. In some examples, the hydrotropic silane coupling agent includes two hydrophobic moieties, a hydrophilic moiety, and a lower alkyl group. In other examples, the hydrotropic silane coupling agent includes one hydrophobic moiety and three hydrophilic or hydrolyzable moieties. In still other examples, the hydrotropic silane coupling agent includes at least one hydrotropic moiety and at least one hydrolyzable moiety.

Some examples of the hydrotropic silicon coupling agents are selected from the group consisting of:

### (aminoethylaminomethyl)phenethyltrimethoxysilane

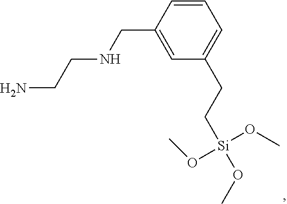 [SMILES: CO[Si](CCc1cccc(CNCCN)c1)(OC)OC]

### bis-(N-methylbenzamido)ethoxymethylsilane

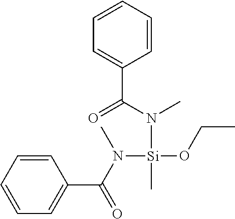 [SMILES: CCO[Si](C)(N(C)C(=O)c1ccccc1)N(C)C(=O)c1ccccc1]

### N—(N-acetylleucyl)-3-aminopropyltriethoxysilane

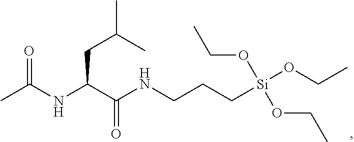 [SMILES: CCO[Si](CCCNC(=O)[C@H](CC(C)C)NC(C)=O)(OCC)OCC]

### 4-(azidosulfonyl)phenethyltrimethoxysilane

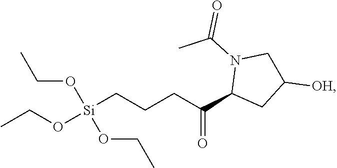 [SMILES: CCO[Si](CCCC(=O)[C@@H]1CC(O)CN1C(C)=O)(OCC)OCC]

3-(N-acetyl-4-hydroxyprolyloxy)propyltriethoxysilane

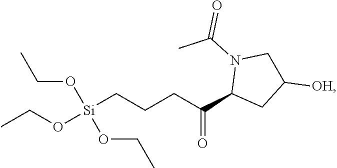 [SMILES: CCO[Si](CCCC(=O)[C@@H]1CC(O)CN1C(C)=O)(OCC)OCC]

### 2-(4-chlorosulfonylphenyl)ethyltrichlorosilane

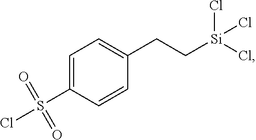 [SMILES: O=S(=O)(Cl)c1ccc(CC[Si](Cl)(Cl)Cl)cc1]

and combinations thereof.

In an example, the modified silica particles may be made through a reaction process referred to herein as silica functionalization. Silica functionalization introduces the hydrotropic silane coupling agent onto the surface of the silica core nanoparticle. More specifically, the silane coupling agent bonds to the silica core nanoparticle, e.g., through the hydrophilic group(s). For example, the alkoxy or halogen group(s) may react with SiOH group(s) to form Si—O—Si bonds.

The silica core nanoparticles may be dispersed in a non-aqueous liquid carrier. A non-aqueous liquid carrier may be desirable because additional hydrolysis reactions do not take place at the surface of the silica cores in this type of environment. As such, the degree of the reaction between the silica core and the hydrotropic silane coupling agent can be better controlled than, for example, when a similar reaction takes place in an aqueous environment. Examples of suitable non aqueous liquid carriers include toluene, isopropanol, and methanol.

The silica core nanoparticles may be added as dry particles to the non-aqueous liquid carrier, or they may be pre-dispersed in another liquid carrier. For example, silica core nanoparticles may be dispersed in isopropyl alcohol or another solvent. This dispersion can be diluted with the non-aqueous liquid carrier to obtain a dispersion with the desirable silica core nanoparticle concentration.

The concentration of the silica core nanoparticles in the non-aqueous liquid carrier ranges from about 1 wt % active to about 10 wt % active. In an example, the concentration of the silica core nanoparticles in the non-aqueous liquid carrier ranges is about 5 wt % active.

The hydrotropic silane coupling agent that is selected is then introduced to the silica core nanoparticle dispersion to form a mixture. The ratio of the hydrotropic silane coupling agent to the silica core nanoparticles in the mixture is a weight ratio ranging from 1:4 up to 1:40. In another example, the weight ratio of the hydrotropic silane coupling agent to the silica core nanoparticles in the mixture ranges from 1:4 up to 1:20. In still another example, the weight ratio of the hydrotropic silane coupling agent to the silica core nanoparticles in the mixture ranges from 1:20 up to 1:40. It has been found that these weight ratios impart a desirable amount of charge to the surface of the modified silica nanoparticles.

The mixture may be heated to a predetermined temperature and allowed to react for a predetermined time. During this time, the mixture may also be stirred. The temperature and time for the reaction may depend, in part, upon the hydrotropic silane coupling agent that is used. The reaction temperature may range from about 60° C. to about 110° C., and the reaction time may range from about 5 hours to about 15 hours. In one example, the mixture is stirred at 80° C. for about 10 hours. During the reaction, the hydrotropic silane coupling agent bonds to the silica core nanoparticle. The modified silica nanoparticles are then washed and dried to remove any organic solvents and unreacted silane coupling agent, and isolate the modified nanoparticles.

In an example, the modified silica nanoparticles have a zeta potential ranging from about −20 mV to about −75 mV. It is to be understood that the zeta potential may vary depending, in part, upon the ratio of the hydrotropic silane coupling agent to the silica core nanoparticles, the size of the silica core nanoparticles, and/or the environment (e.g., pH) in which the modified silica nanoparticles are incorporated.

The zeta potentials for some sample unmodified and modified silica nanoparticles are shown in Table 1 below. The instrument used to measure the zeta potentials was a MOBIUS® from Wyatt Technology.

TABLE 1

| | Average Particle | Zeta Potential (mV) |
|---|---|---|
| Silica Dispersion Sample | size radius (nm) | (average) |
| *ST-N 1% v/v suspension | 16 | −21 |
| (unmodified) | | |
| Modified ST-N 1% v/v | 16 | −28 |
| suspension | | |
| **ST-30-LH 1% v/v suspension | 76 | −43 |
| (unmodified) | | |
| Modified ST-30-LH 1% v/v | 80 | −70 |
| suspension | | |

*ST-N is SNOWTEX ST-N from Nissan Chemical, a colloidal silica solution in water.
**ST-30-LH is SNOWTEX ST-30-LH from Nissan Chemical, a colloidal silica solution in water.

The modified silica nanoparticles may be incorporated into a stock modified silica nanoparticle (MSN) dispersion before being mixed with an overcoat vehicle to form the inkjet overcoat composition. The stock MSN dispersion may be prepared by introducing the dried modified silica nanoparticles into a solvent to yield a dispersion having a predetermined weight percentage of the modified silica nanoparticles. The stock MSN dispersion includes from about 10 wt % to about 40 wt % of the modified silica nanoparticles. In one example, the stock MSN dispersion includes from about 15 wt % to about 35 wt % of the modified silica nanoparticles. In one specific example, the stock MSN dispersion includes about 30 wt % of the modified silica nanoparticles.

The solvent of the stock MSN dispersion may depend, in part, on the overcoat vehicle in which the stock MSN dispersion is to be added. In the examples disclosed herein, the overcoat vehicle is aqueous, and thus the solvent of the stock MSN dispersion may include water. In some instances, water alone is used. In other instances, a mixture of water and 2-pyrrolidone is used. The solvent mixture may depend upon the modified silica nanoparticles and solvent(s) in which they can be dispersed, as well as the overcoat formulation to which the modified silica nanoparticles are to be added. The solvent mixture may be desirable for the stock MSN dispersion when higher amounts of the modified silica nanoparticles are included.

When the modified silica nanoparticles are added to the solvent(s), the pH of the resulting dispersion may be modified to be within the range of 8.5 to 10, or from 9.0 and 9.5. In some instances, a base (e.g., KOH, NaOH, etc.) may be used to adjust the pH. In one example, a 10 wt % KOH solution is used. The dispersion may be then be sonicated at a power level and for a time that are suitable for generating a stable dispersion. In some instances, sonication is performed for up to 5 minutes (e.g., for 1 minute, for 1.5 minutes, etc.) using a probe sonicator at a power ranging from about 10 W to about 20 W. The time for sonication may depend, in part, upon the batch size and the power used, and thus may be longer than 5 minutes. The pH adjustment and sonication may be repeated until the pH remains within the provided range after sonication.

The dispersion may be filtered prior to be incorporated into the inkjet overcoat composition.

Inkjet Overcoat Composition

The inkjet overcoat composition described herein may be comprised of an aqueous (overcoat) vehicle, the modified silica nanoparticles dispersed in the aqueous vehicle, and a sugar alcohol dissolved or dispersed in the aqueous vehicle. In some instances, the inkjet overcoat composition consists of these components, without any other components. In other instances, the inkjet overcoat composition includes an additional component, such as a polymeric binder.

The inkjet overcoat composition is colorless, in part because it is devoid of a colorant, such as a pigment and/or a dye.

Modified Silica Nanoparticles

As described herein, the modified silica nanoparticles include a silica core with a hydrotropic silane coupling agent attached to that core. The modified silica nanoparticles may be prepared as described herein, by attaching the hydrotropic silane coupling agent to the silica core.

The modified silica nanoparticles may be incorporated into the inkjet overcoat composition in the form of the stock MSN dispersion. In these examples, the stock MSN dispersion may be added to the overcoat vehicle or diluted with the overcoat vehicle so that the desired amount of modified silica nanoparticles is incorporated into the overcoat composition. In other examples, the modified silica nanoparticles may be incorporated into the overcoat composition in the form of a powder. In these examples, the solid modified silica nanoparticles may be added to the overcoat vehicle in the desired amount, and sonication may be used to achieve a stable dispersion.

The modified silica nanoparticles are present in the inkjet overcoat composition in an amount ranging from about 2 wt % active to about 10 wt % active based on the total weight of the inkjet overcoat composition. In other examples, the modified silica nanoparticles are present in the inkjet overcoat composition in an amount ranging from about 2.5 wt % active to about 8 wt % active from about 4 wt % active to about 6 wt % active based on the total weight of the inkjet overcoat composition. It is to be understood that these amounts account for the weight percent of the modified silica nanoparticles, and do not account for any solvent(s) that may be added along with the modified silica nanoparticles (e.g., when introduced as part of the stock MNP dispersion).

Sugar Alcohol

The inkjet overcoat composition contains a sugar alcohol, which can be any type of chain or cyclic sugar alcohol. In one example, the sugar alcohol can have the formula: H(HCHO)n+1H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5 carbon sugar alcohol. In another example, the sugar alcohol can be a 6 carbon sugar alcohol. In still another example, the sugar alcohol may be selected from the group consisting of sorbitol, xylitol, mannitol, erythritol, and combinations thereof. Whether a single sugar alcohol is used or a combination of sugar alcohols is used, the total amount of sugar alcohol(s) in the inkjet overcoat composition may range from about 1 wt % to about 15 wt % based on the total weight of the inkjet overcoat composition. Sugar alcohol levels higher than 15 wt % can cause a printability issue from a thermal inkjet printhead due to increased viscosity. In one example, each individual sugar alcohol is present in an amount ranging from 2 wt % up to about 5 wt % based on the total weight of the inkjet overcoat composition. The use of a sugar alcohol can provide improved reliability, excellent curl and rub/scratch resistance.

Polymeric Binder

In some instances, the inkjet overcoat composition further includes a polymeric binder. Example binders may include a polyurethane binder, an (meth)acrylic binder, or the like. Some specific examples of the polymeric binder include waterborne acrylic binders (i.e., those that are water-transportable or water-soluble), styrene (meth)acrylics (e.g., styrene/acrylic/methacrylic binders), styrene maleic anhydrides, polyurethane (meth)acrylics, and polyurethanes. Some specific examples of the polymeric binder may include those chosen from the JONCRYL® family (such as, e.g., JONCRYL® 683), BASF Corp.; the CARBOSET® family and the SANCURE® family, Lubrizol Corp., Wickliffe, Ohio; and the ROSHIELD® family, the Dow Chemical Co., Midland, Mich.

In an example, the inkjet overcoat composition may include a total amount of binder ranging from about 1 wt % actives to about 4 wt % actives based on the total weight of the inkjet overcoat composition. In another example, the binder amount ranges from greater than 0 wt % actives to about 3.5 wt % actives based on the total weight of the inkjet overcoat composition.

Overcoat Vehicle

The aqueous overcoat vehicle as described herein may refer to the liquid component to which the modified silica nanoparticles and the sugar alcohol, and in some instances the polymeric binder, are added to form the inkjet overcoat composition.

In some examples, the aqueous overcoat vehicle may contain an organic co-solvent, a surfactant, a biocide, and water. In still other examples, the aqueous overcoat vehicle also includes a humectant and/or a pH adjuster.

The co-solvent in the aqueous overcoat vehicle may be selected to be miscible with water. The overcoat co-solvent may be the same solvent used in the stock MSN dispersion, or may be compatible with the solvent used in the stock MSN dispersion. One example of a suitable co-solvent is 2-pyrrolidone (2P). Other examples of suitable co-solvents include 1-(2-hydroxyethyl)-2-pyrrolidone (HE2P), 2-ethyl-2-hydroxymethyl-1,3-propanediol) (EHPD), tetraethylene glycol (TEG), combinations thereof, or combinations of any of these with 2P. Still other examples of suitable overcoat vehicle co-solvents include alcohols, such as methanol or ethanol, diols, such as 1,2-hexanediol and 1,2-decanediol, propylene glycol, glycerine, or polyethylene glycol.

Whether a single co-solvent or a combination of co-solvents is used, the total amount of the co-solvent(s) present in the inkjet overcoat composition ranges from about 5 wt % actives to about 15 wt % actives of the total weight of the inkjet overcoat composition.

Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from DuPont, previously known as ZONYL FSO), a combination of nonionic additives (e.g., CARBOWET® GA-211 from Evonik Ind.) and combinations thereof. In other examples, the surfactant is an ethoxylated low-foam wetting agent (e.g., SURFYNOL® 440) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik Ind.).

Whether a single surfactant is used or a combination of surfactants is used, the total amount of surfactant(s) in the inkjet overcoat composition may range from about 0.01 wt % actives to about 2 wt % actives based on the total weight of the inkjet overcoat composition. In an example, the total amount of surfactant(s) in the inkjet overcoat composition ranges from about 0.1 wt % actives to about 1 wt % actives of the total weight of the inkjet overcoat composition.

The inkjet overcoat composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the inkjet overcoat composition may include a total amount of biocides that ranges from about 0.05 wt % actives to about 1 wt % actives, based on a total weight of the inkjet overcoat composition.

The inkjet overcoat composition may also include humectant(s). An example of a suitable humectant is ethoxylated glycerin having the following formula:

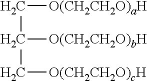

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the inkjet overcoat composition ranges from about 1 wt % actives to about 1.5 wt % actives, based on the total weight of the inkjet overcoat composition. In another example, the total amount of the humectant(s) present in the inkjet overcoat composition ranges from about 1 wt % actives to about 1.25 wt % actives, based on the total weight of the inkjet overcoat composition.

The inkjet overcoat composition disclosed herein may have a pH ranging from about 7 to about 10, and pH adjuster(s) may be added to the inkjet overcoat composition to counteract any slight pH drop that may occur over time. Examples of suitable pH adjusters include metal hydroxide bases, such as sodium hydroxide (NaOH), potassium hydroxide (KOH), etc. In an example, the total amount of pH adjuster(s) in the inkjet overcoat composition ranges from greater than 0 wt % actives to about 0.1 wt % actives (with respect to the total weight of the inkjet overcoat composition).

The balance of the inkjet overcoat composition is water. As such, the amount of water included may vary, depending upon the amounts of the other inkjet overcoat components. As examples, thermal inkjet overcoat compositions may include more water than piezoelectric inkjet overcoat compositions. In an example, the water is deionized water.

The inkjet overcoat may be prepared by first preparing the modified silica nanoparticles as described herein, and then mixing together the overcoat vehicle, the modified silica nanoparticles, and the sugar alcohol, with or without the other additives disclosed herein.

Inkjet Ink Composition

Any inkjet ink may be used with the inkjet overcoat composition. The inkjet ink composition includes a colorant dispersed in an aqueous ink vehicle. In some instances, the inkjet ink composition consists of these components, without any other components.

Colorant

The colorant in the inkjet ink may be a pigment, a dye, or a combination thereof. Whether a pigment and/or a dye is/are included, the colorant can be any of a number of primary or secondary colors, or black or white. As specific examples, the colorant may be any color, including, as examples, a cyan pigment and/or dye, a magenta pigment and/or dye, a yellow pigment and/or dye, a black pigment and/or dye, a violet pigment and/or dye, a green pigment and/or dye, a brown pigment and/or dye, an orange pigment and/or dye, a purple pigment and/or dye, a white pigment and/or dye, or combinations thereof. In one example, the colorant includes a magenta pigment and a magenta dye.

In some examples, the colorant may be a dye. As used herein, “dye” refers to compounds or molecules that absorb electromagnetic radiation or certain wavelengths thereof. Dyes can impart a visible color to the inkjet ink if the dyes absorb wavelengths in the visible spectrum.

The dye (prior to being incorporated into the ink formulation), may be dispersed in water alone or in combination with an additional water soluble or water miscible co-solvent. It is to be understood however, that the liquid components of the dye dispersion become part of the ink vehicle in the inkjet ink composition.

In some examples, the dye may be present in an amount ranging from about 0.5 wt % active to about 15 wt % active based on a total weight of the inkjet ink composition. In one example, the dye may be present in an amount ranging from about 1 wt % active to about 10 wt % active. In another example, the dye may be present in an amount ranging from about 5 wt % active to about 10 wt % active.

The dye can be nonionic, cationic, anionic, or a mixture of nonionic, cationic, and/or anionic dyes. The dye can be a hydrophilic anionic dye, a direct dye, a reactive dye, a polymer dye or an oil soluble dye. Specific examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include ORASOL® Blue GN, ORASOL® Pink, and ORASOL® Yellow dyes available from BASF Corp. Black dyes may include Direct Black 154, Direct Black 168, Fast Black 2, Direct Black 171, Direct Black 19, Acid Black 1, Acid Black 191, Mobay Black SP, and Acid Black 2.

In some examples, the colorant may be a pigment. As used herein, “pigment” may include charge dispersed (i.e., self-dispersed) organic or inorganic pigment colorants. The following examples of suitable pigments can be charged and thus made self-dispersible.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

The average particle size of the pigments may range anywhere from about 50 nm to about 200 nm. In an example, the average particle size ranges from about 80 nm to about 150 nm.

The pigment may be incorporated into the inkjet ink composition in the form of a pigment dispersion, in which the pigment is self-dispersed. In the examples disclosed herein, the pigment may be present in the ink composition in an amount ranging from about 2 wt % actives to about 5 wt % actives based on the total weight of the inkjet ink composition. In another example, the pigment amount ranges from about 4 wt % actives to about 5 wt % actives based on the total weight of the inkjet ink composition. When the pigment is added in the form of a pigment dispersion, the amount of dispersion may be selected so that from about 2 wt % actives (i.e., pigment) to about 5 wt % actives is incorporated into the thermal inkjet ink composition. It is to be understood that the active percentage accounts for the pigment amount, and does not reflect the amount of other dispersion components that may be included.

Ink Vehicle

The “ink vehicle” as described herein may refer to the liquid component to which the colorant is added to form the inkjet ink composition. In some examples the ink vehicle may contain water, a co-solvent, and a surfactant. In other examples, the inkjet ink includes an additive selected from the group consisting of an anti-kogation agent, a humectant, a biocide, a pH adjuster, sequestering agents, binder, and a combination thereof.

Examples of co-solvents for the ink vehicle include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of alcohols may include ethanol, isopropyl alcohol, butyl alcohol, and benzyl alcohol. Other specific examples include tripropylene glycol methyl ether, tripropylene glycol n-butyl ether, 2-ethyl-2-(hydroxymethyl)-1,3-propane diol (EPHD), 2-methyl-1,3-propanediol, 1,2-butanediol, dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

The co-solvent may also include a hydantoin. An example of a hydantoin is di(2-hydroxyethyl)-5,5-dimethylhydantoin.

The co-solvent(s) may be present in the inkjet ink composition an amount ranging from about 4 wt % to about 30 wt % (based on the total weight of the inkjet ink composition).

The inkjet ink composition may include a surfactant. Any of the surfactants described herein for the inkjet overcoat composition may be used, in any of the amounts set forth herein for the overcoat composition, except that the amount is with respect to the total inkjet ink composition.

In some examples, the inkjet ink composition includes an anti-kogation agent. Kogation refers to the deposit of dried ink on a heating element of a thermal inkjet printhead. Anti-kogation agent(s) is/are included in thermal inkjet ink formulations to assist in preventing the buildup of kogation. Examples of suitable anti-kogation agents include oleth-3-phosphate (commercially available as CRODAFOS™ 03A or CRODAFOS™ N-3 acid) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The anti-kogation agent may be present in the inkjet ink composition in an amount ranging from about 0.01 wt % actives to about 1 wt % actives of the total weight of the inkjet ink composition. In another example, the anti-kogation agent may be present in the inkjet ink composition in an amount ranging from about 0.01 wt % actives to about 0.1 wt % actives of the total weight of the inkjet ink composition. In the examples disclosed herein, the anti-kogation agent may improve the jettability of the inkjet ink, for example, when jetted from a thermal inkjet printhead.

The inkjet ink composition may also include humectant(s). Any of the humectant(s) described herein for the inkjet overcoat composition may be used, in any of the amounts set forth herein for the overcoat composition, except that the amount is with respect to the total inkjet ink composition.

The inkjet ink composition may also include biocide(s). Any of the biocide(s) described herein for the inkjet overcoat composition may be used, in any of the amounts set forth herein for the overcoat composition, except that the amount is with respect to the total inkjet ink composition.

The inkjet ink composition disclosed herein may have a pH ranging from about 7 to about 10, and pH adjuster(s) may be added to the inkjet ink composition to counteract any slight pH drop that may occur over time. Examples of suitable pH adjusters include metal hydroxide bases, such as sodium hydroxide (NaOH), potassium hydroxide (KOH), etc. In an example, the total amount of pH adjuster(s) in the inkjet ink composition ranges from greater than 0 wt % actives to about 0.1 wt % actives (with respect to the total weight of the inkjet ink composition).

Sequestering agents (or chelating agents) may be included in the inkjet ink composition to eliminate the deleterious effects of heavy metal impurities. Examples of sequestering agents include disodium ethylenediaminetetraacetic acid (EDTA-Na), ethylene diamine tetra acetic acid (EDTA), and methylglycinediacetic acid (e.g., TRILON® M from BASF Corp.). Whether a single sequestering agent is used or a combination of sequestering agents is used, the total amount of sequestering agent(s) in the inkjet ink composition may range from greater than 0 wt % actives to about 2 wt % actives based on the total weight of the inkjet ink composition.

The inkjet ink composition may also include a binder. Any of the binder(s) described herein for the inkjet overcoat composition may be used, in any of the amounts set forth herein for the overcoat composition, except that the amount is with respect to the total inkjet ink composition. In an example, the binder amount in the inkjet ink composition ranges from greater than 0 wt % actives to about 1 wt % actives based on the total weight of the inkjet ink composition.

The balance of the inkjet ink composition is water. As such, the amount of water included may vary, depending upon the amounts of the other inkjet ink components. As examples, thermal inkjet compositions may include more water than piezoelectric inkjet compositions. In an example, the water is deionized water.

The inkjet ink composition may be prepared by mixing together the ink vehicle, and then mixing the colorant in the ink vehicle.

Inkjet Fluid and Printing Kits

An inkjet fluid kit comprises an inkjet ink including an aqueous ink vehicle, and a pigment dispersed in the aqueous ink vehicle; and a colorless inkjet overcoat composition, including an aqueous overcoat vehicle, modified silica nanoparticles dispersed in the aqueous vehicle, each modified silica nanoparticle including a silica core and a hydrotropic silane coupling agent attached to the silica core; and a sugar alcohol dissolved or dispersed in the aqueous vehicle.

Any example of the inkjet ink composition and any example of the inkjet overcoat composition disclosed herein may be used in the inkjet fluid kit.

An inkjet printing kit includes a recording medium; an inkjet ink composition; and an inkjet overcoat composition, including: an aqueous (overcoat) vehicle, the modified silica nanoparticles dispersed in the aqueous vehicle, and a sugar alcohol dissolved or dispersed in the aqueous vehicle.

In an example, the recording medium in the printing kit is plain paper or coated paper, such as glossy, satin, or offset media.

Any example of the inkjet ink composition and any example of the inkjet overcoat composition disclosed herein may be used in the inkjet printing kit.

It is to be understood that the components of the fluid kit and/or the printing kit may be maintained separately until used together in examples of the printing method disclosed herein.

Printing Method

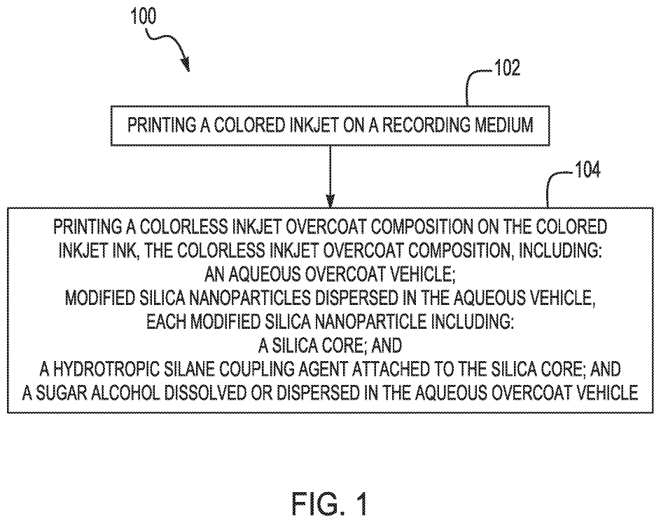

FIG. 1 depicts an example of the printing method 100. As shown in FIG. 1, an example of the printing method 100 comprises printing a colored inkjet ink on a recording medium, as shown at reference numeral 102; and printing a colorless inkjet overcoat composition on the colored inkjet ink, the colorless inkjet overcoat composition, including: an aqueous overcoat vehicle; modified silica nanoparticles dispersed in the aqueous vehicle, each modified silica nanoparticle including: a silica core; and a hydrotropic silane coupling agent attached to the silica core; and a sugar alcohol dissolved or dispersed in the aqueous vehicle, as shown at reference numeral 104.

Any example of the inkjet ink composition and any example of the inkjet overcoat composition disclosed herein may be used in the method 100.

The inkjet ink composition and the inkjet overcoat composition disclosed herein may be applied directly onto the recording medium using any suitable inkjet printing technique. The inkjet ink composition(s) and the inkjet overcoat composition(s) may be ejected onto the recording medium using any suitable applicator, such as a thermal inkjet printhead, a piezoelectric printhead, a continuous inkjet printhead, etc. In some examples, the printing is performed with a high speed (e.g., from about 50 fpm to about 1000 fpm) inkjet printing apparatus, including thermal inkjet printers or web presses, piezoelectric inkjet printers or web presses, continuous inkjet printers or web presses.

The applicator may eject the compositions in a single pass or in multiple passes. As an example of single pass printing, the cartridge(s) of an inkjet printer deposit the desired amount of the inkjet ink composition and the inkjet overcoat composition during the same pass of the cartridge(s) across the recording medium. In this example of the printing method 100, no drying operation is performed after the inkjet ink composition is applied on the medium. Rather, while the inkjet ink composition is wet, the inkjet overcoat composition is deposited on the inkjet ink composition on the medium. As such, it is to be understood that the overcoat composition is applied while previously deposited ink layers are still wet. If desirable, drying operation may then be performed.

In other examples, the cartridge(s) of an inkjet printer deposit the desired amount of the inkjet ink composition and the inkjet overcoat composition over several passes of the cartridge(s) across the recording medium. In some of these examples, the inkjet ink composition is deposited in a first pass and the inkjet overcoat composition is applied in a second pass. In these examples, a drying operation may be performed between the passes. For example, after applying the inkjet ink composition onto the medium, a drying operation may be performed before any subsequent printing takes place. The drying operation(s) may be performed at ambient temperature or under heat using a heating device (e.g., heat lamp, oven, etc.). For example, the drying operation may be performed at about 80° C., or in some examples, at about 100° C.

To further illustrate the present disclosure, examples are given herein. It is to be understood that these examples are provided for illustrative purposes and are not to be construed as limiting the scope of the present disclosure.

### EXAMPLES

### Example 1

Hydrotropically-modified silica nanoparticles were prepared. A hydrotropic silane coupling agent (2-(4-Chlorosulfonylphenyl)ethyltrichlorosilane) was used to prepare the hydrotropically-modified silica nanoparticles.

A silica dispersion in isopropyl alcohol was used to prepare the hydrotropically-modified silica nanoparticles. The average particle size of the silica in the dispersion ranged from 10 nm to 20 nm. The dispersion was diluted with toluene until a solution with 5 wt % silica was achieved.

2-(4-Chlorosulfonylphenyl)ethyltrichlorosilane (the hydrotropic silane coupling agent) was added to the silica/toluene solution at a ratio of 1 SCA:10 silica nanoparticles, and was stirred at 80° C. for 10 hours. The solids from this mixture were collected and washed with hexanes yielding hydrotropically-modified silica nanoparticles. The hydrotropically-modified silica nanoparticle solids were allowed to dry under vacuum at 100° C. overnight to remove any residual organic solvents.

A hydrotropic silica dispersion was prepared by mixing the hydrotropically-modified silica nanoparticle solids in water. The final dispersion included about 30 wt % of the hydrotropically-modified silica nanoparticle solids.

Three different overcoat compositions were prepared using the modified silica dispersion according to the examples disclosed herein. A comparative overcoat composition was prepared without any of the modified silica dispersion. Each of the overcoat compositions is set forth in Table 2, with the wt % active of each component that was used. For example, the weight percentage of the modified silica dispersion represents the total nanoparticle solids (i.e., the modified silica nanoparticles) present in the final overcoat formulations. In other words, the amount of the modified silica dispersion added to the overcoat compositions was enough to achieve a modified silica solids level equal to the given weight percent. Additionally, a 5 wt % potassium hydroxide aqueous solution was added to each of the overcoat compositions until a pH ranging from 8.5 to 9.0 was achieved.

TABLE 2

| | | | | | Comp. |
|---|---|---|---|---|---|
| | | OC 1 | OC 2 | OC 3 | OC 4 |
| Ingredient | Specific Component | (wt %) | (wt %) | (wt %) | (wt %) |
| Silica | Hydrotropic silica | 2 | 4 | 8 | — |
| Dispersion | dispersion | | | | |
| Co-solvent | 2-pyrrolidone | 4 | 4 | 7.5 | 4 |
| | 1,2-diol(s) | 4.1 | 4.1 | 4.2 | 4.1 |
| Sugar | Sorbitol | 3 | 3 | 4 | 3 |
| Alcohol | | | | | |
| Surfactant | Sodium dodecyl | 0.1 | 0.1 | 0.2 | 0.1 |
| | sulfate | | | | |
| | non-ionic surfactant | 0.7 | 0.7 | 0.7 | 0.7 |
| Humectant | Ethoxylated Glycerol | 2 | 2 | 2 | 2 |
| Binder | Styrene/Acrylic/ | 1.5 | 1.5 | 1 | 1.5 |
| | Methacrylic acid | | | | |
| | copolymer | | | | |
| | Acrylic resin | 1.5 | 1.5 | 1 | 1.5 |
| Water | Deionized water | Balance | Balance | Balance | Balance |

Green and blue inks were used in this example. The ink compositions are set forth in Table 3, with the wt % active of each component that was used. For example, the weight percentage of the pigment dispersion represents the total pigment solids (i.e., the pigment particles) present in the final overcoat formulations. Additionally, a 5 wt % potassium hydroxide aqueous solution was added to each of the ink compositions until a pH ranging from 9.0 to 9.5 was achieved.

TABLE 3

| | | Green Ink | Blue Ink |
|---|---|---|---|
| Ingredient | Specific Component | (wt %) | (wt %) |
| Colorant | Green pigment dispersion | 0.4 | — |
| | Cyan/violet pigment dispersion | — | 0.3 |
| Co-solvent | 2-pyrrolidone | 5 | 7 |
| | Diethylene glycol | 6 | 1.5 |
| | Glycerol | 4 | 4 |
| | 1,2-hexanediol | 4 | 4 |
| | Triethylamine | 0.7 | — |
| Buffer | TRIS | 0.1 | 0.1 |
| Surfactant | fluorosurfactant | 0.2 | 0.1 |
| | ethoxylated acetylenic surfactant | 0.5 | 0.5 |
| | non-ionic surfactant | 0.2 | 0.2 |
| Humectant | Ethoxylated Glycerol | 3.5 | 3.0 |
| Anti-kogation | Hexamethylenediamine | 0.4 | 0.2 |
| Agent | tetra(methylene phosphonic | | |
| | acid), potassium salt | | |
| Binder | Styrene/Acrylic/Methacrylic | 0.7 | — |
| | acid copolymer | | |
| | Acrylic resin | — | 2 |
| Biocide | 20% aqueous dipropylene glycol | 0.2 | 0.2 |
| | solution of | | |
| | 1,2-benzisothiazolin-3-one | | |
| Water | Deionized water | Balance | Balance |

Four different prints were generated on HP Universal Instant-dry Glossy photo media with the green ink. For each print, the green ink was printed i) at 100% fill density to form 5 green stripes and ii) at 125% fill density to form 5 additional green stripes.

A different overcoat was then printed on some of the stripes of the respective prints. Two stripes (control stripes 1 and 6) in each print had no overcoat printed thereon. Each other stripe in each print had one of the overcoats printed at a different fill density.

Wet on wet printing was used for each print. As such, for those stripes including both ink and an overcoat, a single print pass deposited the green ink and then the respective overcoat composition. Table 4 provides a guide for each print, including the stripe number (from the top of the print to the bottom of the print), the green ink level (fill density) of each stripe, the overcoat used for the particular print, and the overcoat level (fill density).

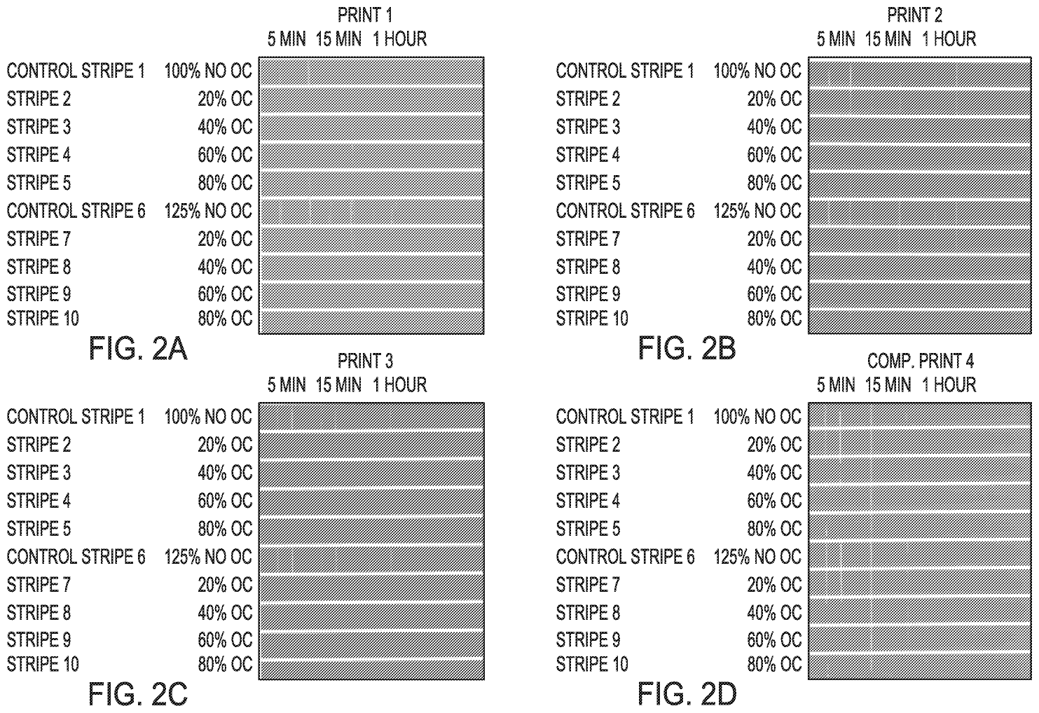

TABLE 4

| | PRINT 1 (FIG. 2A) | | PRINT 2 (FIG. 2B) | |
|---|---|---|---|---|
| | % green ink | % OC 1 | % green ink | % OC 2 |
| Control Stripe 1 | 100 | 0 | 100 | 0 |
| Stripe 2 | 100 | 20 | 100 | 20 |
| Stripe 3 | 100 | 40 | 100 | 40 |
| Stripe 4 | 100 | 60 | 100 | 60 |
| Stripe 5 | 100 | 80 | 100 | 80 |
| Control Stripe 6 | 125 | 0 | 125 | 0 |
| Stripe 7 | 125 | 20 | 125 | 20 |
| Stripe 8 | 125 | 40 | 125 | 40 |
| Stripe 9 | 125 | 60 | 125 | 60 |
| Stripe 10 | 125 | 80 | 125 | 80 |

| | | | COMP. PRINT 4 (FIG. 2D) | |
|---|---|---|---|---|
| | PRINT 3 (FIG. 2C) | | | % Comp. |
| | % green ink | % OC 3 | % green ink | OC 4 |
| Control Stripe 1 | 100 | 0 | 100 | 0 |
| Stripe 2 | 100 | 20 | 100 | 20 |
| Stripe 3 | 100 | 40 | 100 | 40 |
| Stripe 4 | 100 | 60 | 100 | 60 |
| Stripe 5 | 100 | 80 | 100 | 80 |
| Control Stripe 6 | 125 | 0 | 125 | 0 |
| Stripe 7 | 125 | 20 | 125 | 20 |
| Stripe 8 | 125 | 40 | 125 | 40 |
| Stripe 9 | 125 | 60 | 125 | 60 |
| Striae 10 | 125 | 80 | 125 | 80 |

The prints were exposed to a scratch test at different times post-printing. A plastic scratch tip was dragged across each stripe of Prints 1, 2 and 3 at 5 minutes post-printing, 15 minutes post-printing, and 1 hour post-printing. The plastic scratch tip was dragged across each stripe of Comp. Print 4 at 5 minutes post-printing and 15 minutes post-printing.

FIG. 2A, FIG. 2B, FIG. 2C, and FIG. 2D are black and white reproductions of originally colored photographs of Prints 1, 2, 3, and Comp. Print 4, respectively. As depicted in each of the figures, control stripes 1 and 6, without any overcoat composition applied thereon, had the worst scratch marks of all 10 stripes. Moreover, when performing a stripe to stripe comparison between FIG. 2D and FIG. 2A, FIG. 2B or FIG. 2C, stripes 2-5 and 7-10 of Comp. Print 4 had more scratches than respective stripes 2-5 and 7-10 any of Prints 1, 2, or 3. As such, the example overcoats 1-3 (including the modified silica nanoparticles) exhibited improved scratch resistance and durability compared to the comparative overcoat (with no modified silica nanoparticles) printed at the same fill density. Still further, while all of the example overcoats exhibited suitable scratch resistance, the results indicate that a higher weight percentage of the modified silica nanoparticles led to better scratch resistance.

Two different prints were generated on HP Universal Instant-dry Satin photo media with the blue ink. For each print, the blue ink was printed i) at 100% fill density to form 5 blue stripes and ii) at 125% fill density to form 5 additional blue stripes.

Example OC 3 and Comp. OC 4 were then printed on some of the stripes of the respective prints. Two stripes (control stripes 1 and 6) in each print had no overcoat printed thereon. Each other stripe in each print had one of the overcoats printed at a different fill density.

Wet on wet printing was used for each print. As such, for those stripes including both ink and an overcoat, a single print pass deposited the green ink and then the respective overcoat composition. Table 5 provides a guide for each print, including the stripe number (from the top of the print to the bottom of the print), the blue ink level (fill density) of each stripe, the overcoat used for the particular print, and the overcoat level (fill density).

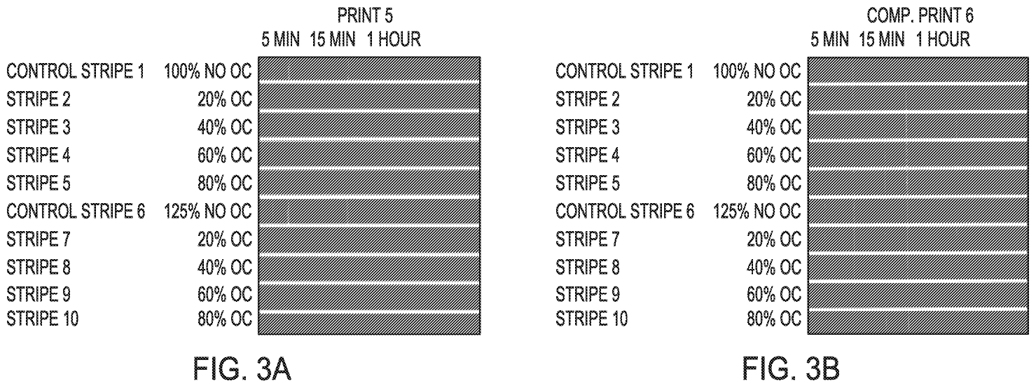

TABLE 5

| | | | COMP. PRINT 6 (FIG. 3B) | |
|---|---|---|---|---|
| | PRINT 5 (FIG. 3A) | | | % Comp. |
| | % blue ink | % OC 3 | % blue ink | OC 4 |
| Control Stripe 1 | 100 | 0 | 100 | 0 |
| Stripe 2 | 100 | 20 | 100 | 20 |
| Stripe 3 | 100 | 40 | 100 | 40 |
| Stripe 4 | 100 | 60 | 100 | 60 |
| Stripe 5 | 100 | 80 | 100 | 80 |
| Control Stripe 6 | 125 | 0 | 125 | 0 |
| Stripe 7 | 125 | 20 | 125 | 20 |
| Stripe 8 | 125 | 40 | 125 | 40 |
| Stripe 9 | 125 | 60 | 125 | 60 |
| Stripe 10 | 125 | 80 | 125 | 80 |

The prints were exposed to a scratch test at different times post-printing. A plastic scratch tip was dragged across each stripe of Print 5 and Comp. Print 6 at 5 minutes post-printing, 15 minutes post-printing, and 1 hour post-printing.

FIG. 3A and FIG. 3B are black and white reproductions of originally colored photographs of Print 5 and Comp. Print 6, respectively.

When performing a stripe to stripe comparison between FIG. 3B and FIG. 3A, stripes 2-5 and 7-10 of Comp. Print 6 had more scratches at 1 hour post-printing than respective stripes 2-5 and 7-10 Print 5. As such, the example OC 3 (including 8 wt % modified silica nanoparticles) exhibited improved scratch resistance and durability compared to the comparative overcoat (with no modified silica nanoparticles) printed at the same fill density on blue ink.

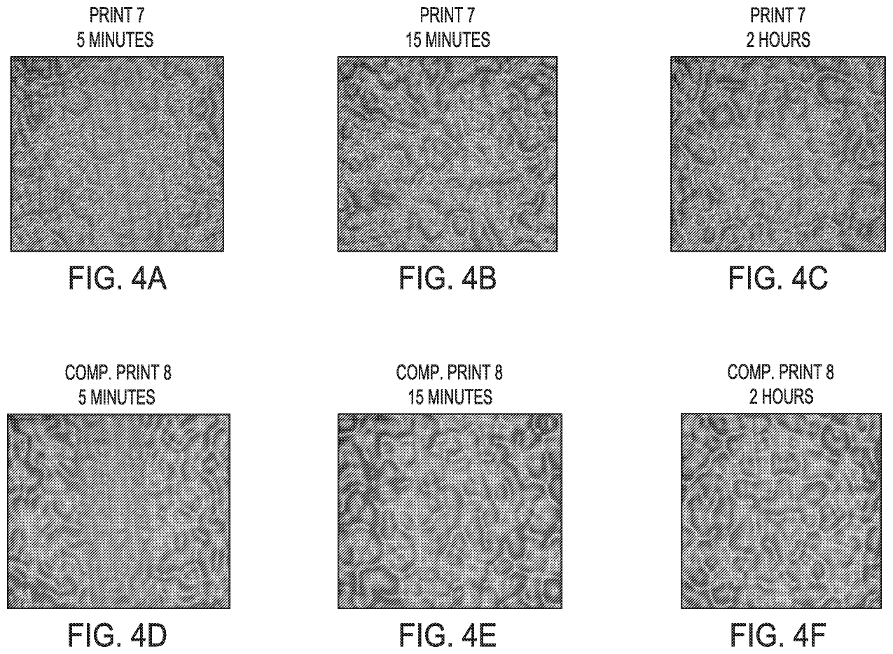

Two additional blue prints (100% fill density) were generated on the Satin photo media. Print 7 had 20% of example OC 3 printed thereon, and Comp. Print 8 had no overcoat printed thereon. The prints were exposed to a scratch test at different times post-printing. A metal scratch tip was dragged across each of Print 7 and Comp. Print 8 at 5 minutes post-printing, 15 minutes post-printing, and 2 hours post-printing. Photomicrographs (with the blue filer removed) were taken after each scratch test. The images of Print 7 are reproduced in black and white in FIG. 4A through 4C, and the images of Comp. Print 8 are reproduced in black and white in FIG. 4D through 4F. These images illustrate that scratch resistance was improved for Print 7.

### Example 2

The modified silica dispersion from Example 1 was used to prepare two additional example overcoat formulations.

Two comparative overcoat formulations were also prepared with a non-modified silica dispersion (i.e., SNOWTEX® N silica dispersion from Nissan Chemical).

Each of the overcoat compositions is set forth in Table 6, with the wt % active of each component that was used. A magenta dye was included in each of these overcoat compositions for visibility during the decap test and the capped recovery test. Additionally, a 5 wt % potassium hydroxide aqueous solution was added to each of the overcoat compositions until a pH ranging from 8.5 to 9.0 was achieved.

TABLE 6

| | | | | Comp. | Comp. |
|---|---|---|---|---|---|
| | | OC 5 | OC 6 | OC 7 | OC 8 |
| Ingredient | Specific Component | (wt %) | (wt %) | (wt %) | (wt %) |
| Silica | Hydrotropic silica | 2 | 4 | — | — |
| Dispersion | dispersion from | | | | |
| | Example 1 | | | | |
| | Non-modified silica | — | — | 2 | 4 |
| | dispersion | | | | |
| Co-solvent | 2-pyrrolidone | 4 | 7.5 | 4 | 4 |
| | 1,2-diol(s) | 4.1 | 4.2 | 4.1 | 4.1 |
| Sugar | Sorbitol | 3 | 4 | 3 | 3 |
| Alcohol | | | | | |
| Surfactant | Sodium dodecyl | 0.1 | 0.2 | 0.1 | 0.1 |
| | sulfate | | | | |
| | non-ionic surfactant | 0.7 | 0.7 | 0.7 | 0.7 |
| Humectant | Ethoxylated Glycerol | 2 | 2 | 2 | 2 |
| Binder | Styrene/Acrylic/ | 1.5 | 1 | 1.5 | 1.5 |
| | Methacrylic acid | | | | |
| | copolymer | | | | |
| | Acrylic resin | 1.5 | 1 | 1.5 | 1.5 |
| Colorant | Magenta Dye | 0.5 | 0.5 | 0.5 | 0.5 |
| Water | Deionized water | Balance | Balance | Balance | Balance |

A decap test was performed with each of the overcoat compositions: OC 5, OC 6, Comp. OC 7, and Comp. OC 8. A decap plot was printed with each of the overcoat compositions and the prints were visually evaluated for missing lines.

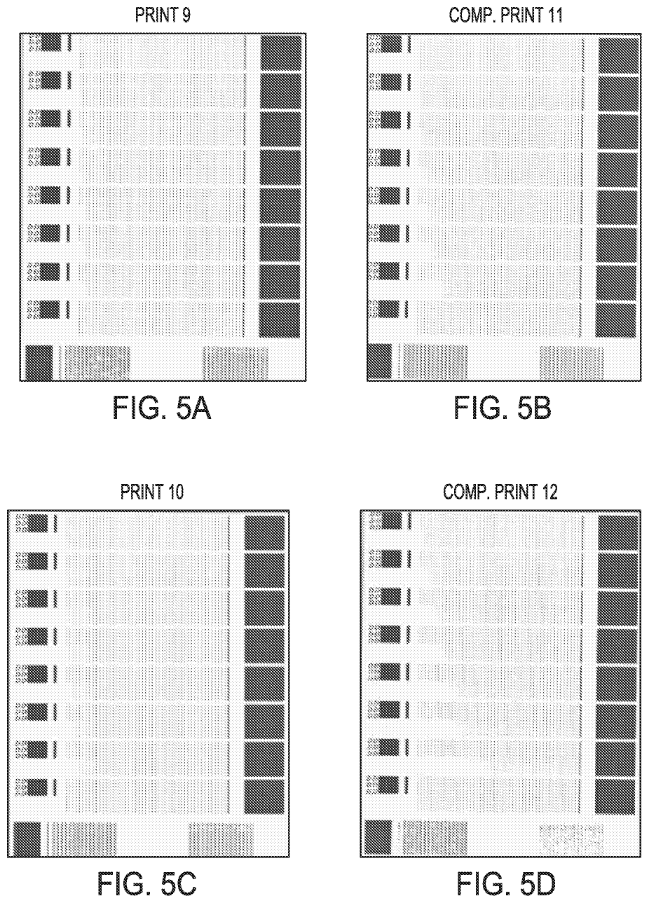

Black and white reproductions of the prints generated with OC 5 (Print 9), OC 6 (Print 10), Comp. OC 7 (Comp. Print 11), and Comp. OC 8 (Comp. Print 12) are shown, respectively, in FIG. 5A, FIG. 5C, FIG. 5B, and FIG. 5D. More specifically, the example and comparative examples prepared with 2 wt % of modified or non-modified silica are shown in FIG. 5A and FIG. 5B, while the example and comparative examples prepared with 4 wt % of modified or non-modified silica are shown in FIG. 5C and FIG. 5D. Comparing FIG. 5A and FIG. 5B, Print 9 (prepared with the example overcoat composition (OC 5) with 2 wt % modified silica) had less missing lines than Comp. Print 11 (prepared with the comparative overcoat composition (Comp. OC 7) with 2 wt % non-modified silica). Similarly, comparing FIG. 5C and FIG. 5D, Print 10 (prepared with the example overcoat composition (OC 6) with 4 wt % modified silica) had less missing lines than Comp. Print 12 (prepared with the comparative overcoat composition (Comp. OC 8) with 4 wt % non-modified silica).

OC 6 (4 wt % modified silica nanoparticles) and Comp. OC 8 (4 wt % non-modified silica nanoparticles) were also tested for capped recovery. The cartridges containing the respective overcoat compositions were capped for 8 days. The caps were removed and the respective overcoats were printed on paper to generate Print 13 and Comp. Print 14.

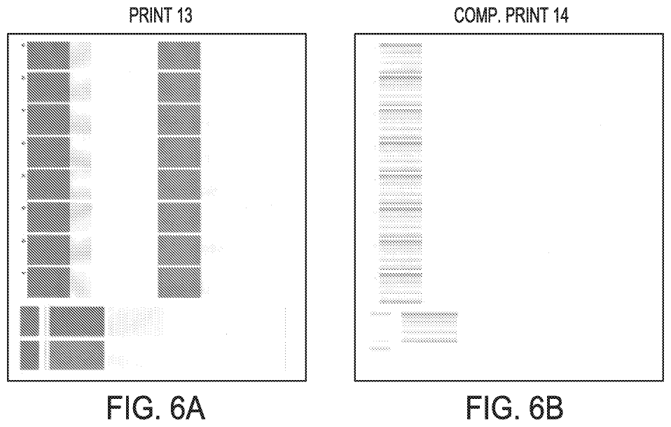

Black and white reproductions of Print 13 and Comp. Print 14 are shown, respectively, in FIG. 6A and FIG. 6B. Print 13 is the first page printed after the capped storage period; whereas Comp. Print 14 is the tenth page printed after the capped storage period. Clearly, OC 6 exhibited better print recovery after capping than did Comp. OC 8. As depicted in FIG. 6B, even after 10 pages were printed, the printability of Comp. OC 8 still had not recovered.

It is to be understood that the ranges provided herein include the stated range and any value or sub-range within the stated range, as if such values or sub-ranges were explicitly recited. For example, a range from about 1 wt % active to about 10 wt % active should be interpreted to include not only the explicitly recited limits of from about 1 wt % active to about 10 wt % active, but also to include individual values, such as 1.25 wt % active, 7 wt % active, 9.5 wt % active, etc., and sub-ranges, such as from about 1.55 wt % active to about 3.75 wt % active, from about 2 wt % active to about 8 wt % active, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet overcoat composition, comprising:
an aqueous vehicle;
modified silica nanoparticles dispersed in the aqueous vehicle, each modified silica nanoparticle including:
a silica core; and
a hydrotropic silane coupling agent attached to the silica core; and
a sugar alcohol dissolved or dispersed in the aqueous vehicle.

2. The inkjet overcoat composition as defined in claim 1 wherein a weight ratio of the hydrotropic silane coupling agent to the silica core ranges from about 1:4 to about 1:40.

3. The inkjet overcoat composition as defined in claim 1 wherein the hydrotropic silane coupling agent is selected from the group consisting of (aminoethylaminomethyl)phenethyltrimethoxysilane, bis-(N-methylbenzamido)ethoxymethylsilane, N—(N-acetylleucyl)-3-aminopropyltriethoxysilane, 4-(azidosulfonyl)phenethyltrimethoxysilane, 3-(N-acetyl-4-hydroxyprolyloxy)propyltriethoxysilane, 2-(4-chlorosulfonylphenyl)ethyltrichlorosilane, and combinations thereof.

4. The inkjet overcoat composition as defined in claim 1 wherein the modified silica nanoparticles are present in an amount ranging from about 2 wt % to about 10 wt % of a total weight of the inkjet overcoat composition.

5. The inkjet overcoat composition as defined in claim 1 wherein the modified silica nanoparticles have a zeta potential ranging from about −20 mV to about −75 mV.

6. The inkjet overcoat composition as defined in claim 1, further comprising a polymeric binder.

7. The inkjet overcoat composition as defined in claim 1 wherein the aqueous vehicle includes an organic co-solvent, a surfactant, a biocide, and water.

8. An inkjet fluid kit, comprising:
an inkjet ink, including:
an aqueous ink vehicle; and
a pigment dispersed in the aqueous ink vehicle; and
a colorless inkjet overcoat composition, including:
an aqueous overcoat vehicle;
modified silica nanoparticles dispersed in the aqueous vehicle, each modified silica nanoparticle including:
a silica core; and
a hydrotropic silane coupling agent attached to the silica core; and
a sugar alcohol dissolved or dispersed in the aqueous vehicle.

9. The inkjet fluid kit as defined in claim 8 wherein the colorless inkjet overcoat composition is devoid of a colorant.

10. The inkjet fluid kit as defined in claim 8 wherein a weight ratio of the hydrotropic silane coupling agent to the silica core ranges from about 1:4 to about 1:40.

11. The inkjet fluid kit as defined in claim 8 wherein the hydrotropic silane coupling agent is selected from the group consisting of (aminoethylaminomethyl)phenethyltrimethoxysilane, bis-(N-methylbenzamido)ethoxymethylsilane, N—(N-acetylleucyl)-3-aminopropyltriethoxysilane, 4-(azidosulfonyl)phenethyltrimethoxysilane, 3-(N-acetyl-4-hydroxyprolyloxy)propyltriethoxysilane, 2-(4-chlorosulfonylphenyl)ethyltrichlorosilane, and combinations thereof.

12. The inkjet fluid kit as defined in claim 8 wherein the modified silica nanoparticles are present in an amount ranging from about 2 wt % to about 10 wt % of a total weight of the colorless inkjet overcoat composition.

13. The inkjet fluid kit as defined in claim 8 as defined in claim 1 wherein the modified silica nanoparticles have a zeta potential ranging from about −20 mV to about −75 mV.

14. A method, comprising:
printing a colored inkjet ink on a recording medium; and
printing a colorless inkjet overcoat composition on the colored inkjet ink, the colorless inkjet overcoat composition, including:
an aqueous overcoat vehicle;
modified silica nanoparticles dispersed in the aqueous vehicle, each modified silica nanoparticle including:
a silica core; and
a hydrotropic silane coupling agent attached to the silica core; and
a sugar alcohol dissolved or dispersed in the aqueous vehicle.

15. The method as defined in claim 14, further comprising drying the colored inkjet ink on the recording medium prior to printing the colorless inkjet overcoat composition.
